(19) United States
(12) Patent Application Publication
(10) Pub. No.: US 2003/0150309 A1
(43) Pub. Date: Aug. 14, 2003

(54) Rip guide setting tool

(76) Inventors: Roger D. Goodwin, Clarks Summit, PA (US); Robert R. Hill, Rogers, AR (US)

Correspondence Address: Sanford J. Piltch, Esq., Suite 207, 1132 Hamilton Street, Allentown, PA, 18101-1024, US

(21) Appl. No.: 10/074,275

(22) Filed: Feb. 12, 2002

(51) Int. Cl. B27B 27/04

(52) U.S. Cl. 83/435.12; 83/477.2

(57) ABSTRACT

A rip guide setting tool for use in positioning and aligning elements of a table saw including the cutting blade and the rip fence or guide utilizing opposing arms of uniform length dimension pinned at their respective ends forming a parallelogram configuration which is adjustable to desired distances for achieving the alignment and positioning of the element or elements using one of the miter channels of the saw as an alignment reference.

### BACKGROUND OF THE INVENTION

The invention relates to an alignment tool useful in aligning the cutting tool and cut alignment fence of a table saw. The tool provides for the proper perpendicular and parallel alignment of the various cutting tools and cutting guides arrayed across the table surface.

Table saws have almost uniformly provided problems in alignment from their inception. The cutting blade must be aligned so that the cut is straight along the intended direction, i.e. cut, on the workpiece. In addition, the rip guide or fence must be aligned to provide a parallelity between the cutting tool and the rip fence in order that the cut made on the workpiece is straight along the intended direction. A number of devices have been utilized to achieve the alignment of the cutting tool and the rip guide or fence; some complicated and some not so complicated.

In U.S. Pat. No. 4,713,993 [Litowitz] a table saw guide is described which includes a series of arms pivoted outward from one guide bar toward a second guide bar proximate the cutting blade. The arms are interconnected so that two parallelogram shapes are formed between the guide bars and a centrally positioned arm connecting the common pivot points of the parallel extension arms from each of the guide bars. The problem which exists with this alignment arrangement is the outer guide bar must be aligned using the guide rails positioned along the sides of the table to create a perpendicularity between them so that the inner guide bar can be used as the rip guide for cutting the work piece. In this manner, there is no certainty that either the outer guide bar is actually perpendicular to the table edges, and thus parallel to the cutting blade, as there is no common point from which the alignment is made. Further, there is no certainty the cutting blade is aligned perpendicularly to the edges of the table, and thus parallel to the guide bars. If, as described, the cutting blade is aligned using the paired guide bars, the process is cumbersome and complicated to set up and perform the alignment.

A second patent, U.S. Pat. No. 5,353,515 [Alvis, et al.], describes an alignment gauge which utilizes the miter channel as a starting point for aligning the rip fence a measured distance from the cutting blade. The rip fence, when positioned against the distal ends of the twin rules of the alignment apparatus should be aligned in parallelity with the miter channel if the perpendicular adjustment of the alignment apparatus is properly set. The problem arises in ascertaining whether the rip fence is in parallelity with the cutting blade. In other words, do the separated twin straight edges of the alignment apparatus create twin reference points against which the rip fence may be placed such that parallelity is certain? Due to the fallacy of adjusting a number of different set points, there is no constancy of alignment between and among the apparatus, the cutting blade, and the rip fence, and thus, no certain parallelity.

Most of the problems with existing alignment apparatus is that they do not constrain the alignment to originate at a single reference point. Also, most of the existing alignment apparatus require a complicated series of steps to align the rip fence (or substitute rip fence) with the cutting blade, or another reference point on the saw table. Each of the steps for alignment create another potential occurrence of misalignment of the rip fence and the cutting blade with the consequences being an almost parallel relationship causing a skewed cut on the workpiece.

Another problem occurs when using the cutting blade as the reference point for alignment. If the cutting blade is not perfectly aligned perpendicular to the direction of travel of the workpiece, then the cut will tend to be skewed (ever so slightly) because all of the elements of the saw will be aligned to a misaligned element, i.e. the cutting blade. This will occur because the cutting blade is susceptible to rotational deviation in both the horizontal and vertical planes passing through its center. The cutting blade orientation can be altered for an angled cut in the vertical plane and if not returned to the neutral perfect vertical position it may create a misalignment if used as the reference for other saw elements. Also, the cutting blade can be misaligned when replaced or exchanged for another and not returned to a perfect neutral horizontal position creating a skewed cut laterally and similar lateral misalignment of other saw elements.

The present invention utilizes one of the machined channels in the top surface of the saw table as the primary reference point for aligning both the cutting blade and the rip fence or guide. The channels are machined perpendicular to the sides of the saw table and are not susceptible to alteration of direction or orientation as is the cutting blade. Alignment of the cutting blade to one (or both) of the channels perfectly aligns the cutting blade to a true cross-table direction and vertical rotation. Once the cutting blade is properly aligned, the rip fence or guide can be aligned to the same reference point, i.e. the machined channel, so that the cutting blade and rip fence are aligned to the same reference point using the same tool.

It is, therefore, an object of the present invention to properly align the cutting blade and rip fence or guide utilizing an alignment tool positioned in the same reference point. It is also an object of the present invention to provide a simple to use tool which mates easily with the top surface of a table saw to properly align the cutting blade and rip fence or guide to be parallel to each other, and to the direction of cutting a workpiece, i.e. in the cross-table direction.

It is a further object of the present invention to provide a simple expandable tool to use to align the cutting blade and rip fence, which tool maintains parallelity between its elongated guide members so that it may transmit the maintained parallelity to the cutting blade and the rip fence or guide.

Other objects will appear hereinafter.

### SUMMARY OF THE INVENTION

A rip guide setting tool for use in positioning and aligning elements of a table saw including the cutting blade and the rip fence or guide is described. The alignment and setting tool utilizes opposing arms of uniform length dimension pinned at their respective ends to form a parallelogram configuration. The geometry of the parallelogram is adjustable to desired distance or measurement relationships for achieving the alignment and positioning of the element or elements using one of the miter channels on the saw table as an alignment reference.

The invention concerns a rip guide setting apparatus for use in positioning and aligning elements of a table saw. The apparatus or setting tool comprises a base arm having a rectangular cross-section for mating with and operatively engaging an alignment reference on the top of said table saw. A positioning and alignment arm is positioned opposite the base arm which has a height above the table of substantially the same as the base arm. A pair of extension arms extending between the base and positioning and alignment arms which are used to fixedly connect the arms at their ends to the opposing respective ends of the positioning and alignment arm and to one opposing end of the base arm. The remaining opposing end of the base arm is connected to the opposing respective end of one of the extension arms which creates a parallel relationship between opposing arms. These connections can be adjustably tightened to fix the geometric configuration and dimensional extension of the arms for placing one or more elements of the table saw against the positioning and alignment arm to align the one or more elements with the alignment reference.

The alignment reference is an elongated channel cut into the top of the table and which extends from one edge of the table to the other. Each of the arms at their respective connection points are capable of rotational motion about the connection point. The setting tool also has a manually adjustable knob for tightening the connection between the extension arm and the remaining opposing end of the base arm. A stop is located on the base arm for preventing the extension arms to over-extend and distort the parallelity of the arms.

### BRIEF DESCRIPTION OF THE DRAWINGS

For the purpose of illustrating the invention, there is shown in the drawings forms which are presently preferred; it being understood, however, that the invention is not limited to the precise arrangements and instrumentalities shown.

FIG. 1 is a perspective view of the alignment apparatus of the present invention.

FIG. 2 is a top plan view of the present invention.

FIG. 3 is an exploded view of one adjustable joint of the present invention.

FIG. 4 is an exploded view of the setting adjustable joint of the present invention.

FIG. 5 is a top plan view of the present invention showing the parallel alignment of the arms of the present invention.

FIG. 6 is a perspective view of the present invention in position on a saw table used as a guide for aligning the rip guide or fence dimensionally positioned for cutting a workpiece.

### DETAILED DESCRIPTION OF THE PREFERRED EMBODIMENTS

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

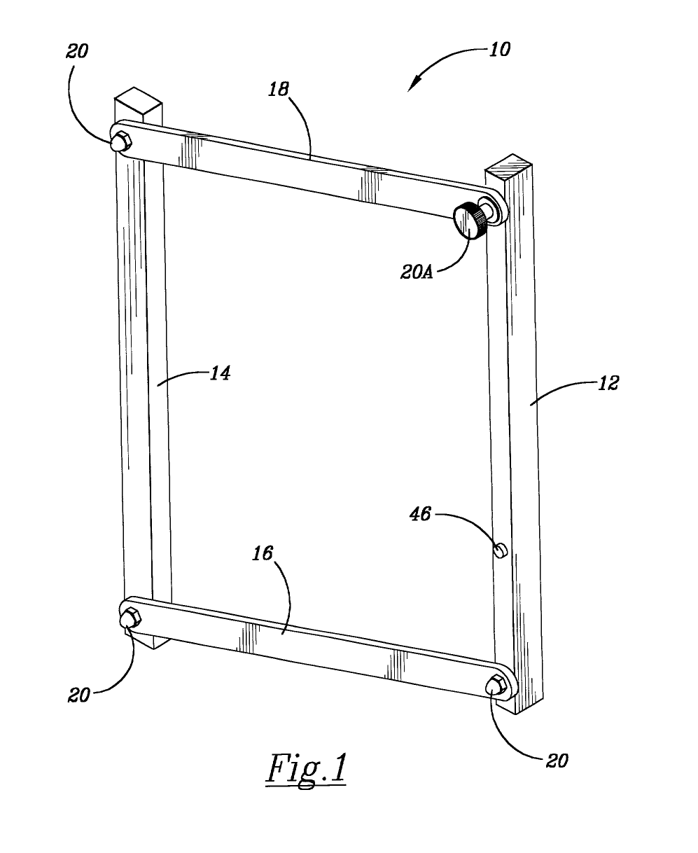

Referring now to the drawings in detail, where like numerals refer to like parts or elements, there is shown in FIG. 1 the rip guide setting tool 10 of the present invention. The setting or alignment tool 10 is comprised of four arms interconnected at their respective ends as follows. A base arm 12 having a rectangular cross-section is dimensioned to be placed within a machined channel located on the cutting table of a table saw and extend upward and above the table surface a height substantially equivalent to the substantially square, in cross-section, alignment arm 14. Both the base arm 12 and the alignment arm 14 are of equivalent length and connected together at their ends by a pair of extension arms 16, 18. The extension arms 16, 18 are of uniform dimensions; length, width and depth, such that their respective connection at the ends of the base and alignment arms 12, 14 create a parallelity between the extension arms 16, 18. With the parallelity of the extension arms 16, 18, the base and alignment arms 12, 14 are also aligned in parallel The resulting configuration of the arms 12-18 is a parallelogram.

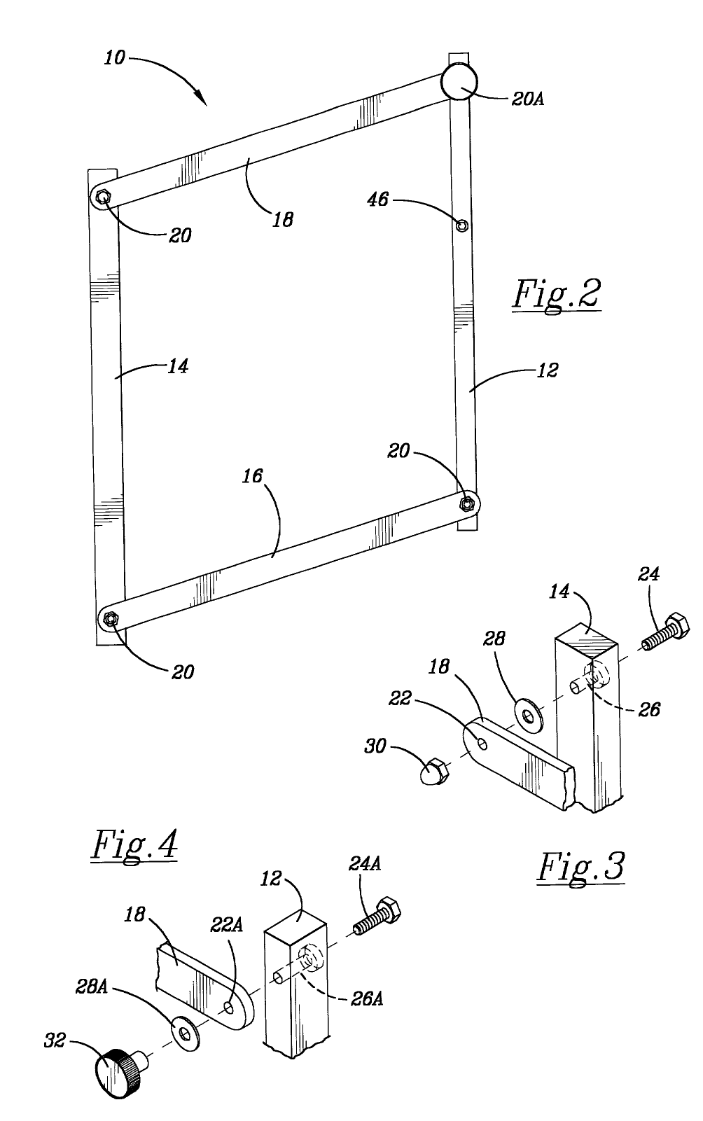

At the respective ends of each of the arms 12-18 are a series of connectors 20 which can be described best with reference to FIGS. 2 through 4. FIG. 3 shows one of the connectors 20 arranged between alignment arm 14 and extension arm 18. A hole 22 is placed in extension arm 18 to accommodate bolt 24 which is placed through a recessed hole 26 capable of entirely housing bolt 24 in order that the bolt fits flush to the underside of arm 14. Bolt 24 as positioned in alignment arm 14 extends upward through hole 26 and into and through hole 22 in extension arm 18. Around bolt 26 and between the opposing surfaces of arms 14 and 18 a flat washer 28 is placed to facilitate rotational motion between the arms 14, 18 when the connector is assembled and tightened. In order to secure the arms 14, 18 together, a cap nut 30 is placed over the threaded end of bolt 24 and tightened until the connector 20 holds the arms 14, 18 against one another as shown in FIGS. 1 and 2.

The described connector 20 also holds the arms 12 and 16 together, as well as arms 14 and 16 together, in the same manner and with the same elements as just described in this way three of the corners of the parallelogram are attached together so that rotational motion between the respective arms about the connectors 20 is possible. At the fourth corner, the connector 20A is special as it is capable of manual tightening so as to fix the setting tool into a desired alignment of the arms 12-18.

Connector 20A may be described with reference to FIG. 4. Bolt 24A is placed into and through recessed hole 26A in base arm 12 and then into and through hole 22A in extension arm 18. Bolt 24A fits flush to the bottom surface of arm 12 as it fits entirely within hole 26A. Flat washer 28A is placed around bolt 24A above arm 18 and tightening knob 32 is placed over the threaded end of bolt 24A in order to secure the arms against one another as shown in FIGS. 1 and 2. In this manner the tightening knob 32 can be loosened to permit the realignment of the arms 12-18 to a different alignments or configurations of parallelograms which produce a number of different spacings or distances between the base arm 12 and the alignment arm 14. Two exemplary alignments or configurations of the setting tool 10 are shown in FIG. 5.

To achieve a shorter dimensional spacing, i.e. distance, between the base arm 12 and the alignment arm 14, the angle taken at connector 20A between arms 12 and 18 is significantly lessened, closing the parallelogram configuration of the setting tool 10. This creates a shortened distance between the outer surface of base arm 12 and the outer surface of alignment arm 14 while keeping these two surfaces in substantial parallelity. This configuration will permit the alignment of an element of the table saw with the setting tool 10 which is dimensionally close to the machined channel (or miter cut) in the table top. If the element to be aligned is farther away from the machined channel, then the setting tool 10 is expanded to a greater angle taken at connector 20A as shown in phantom lines in FIG. 5. In this manner, the setting tool 10 can be utilized to align elements at differing distances from the machined channel cut into the top of the table saw.

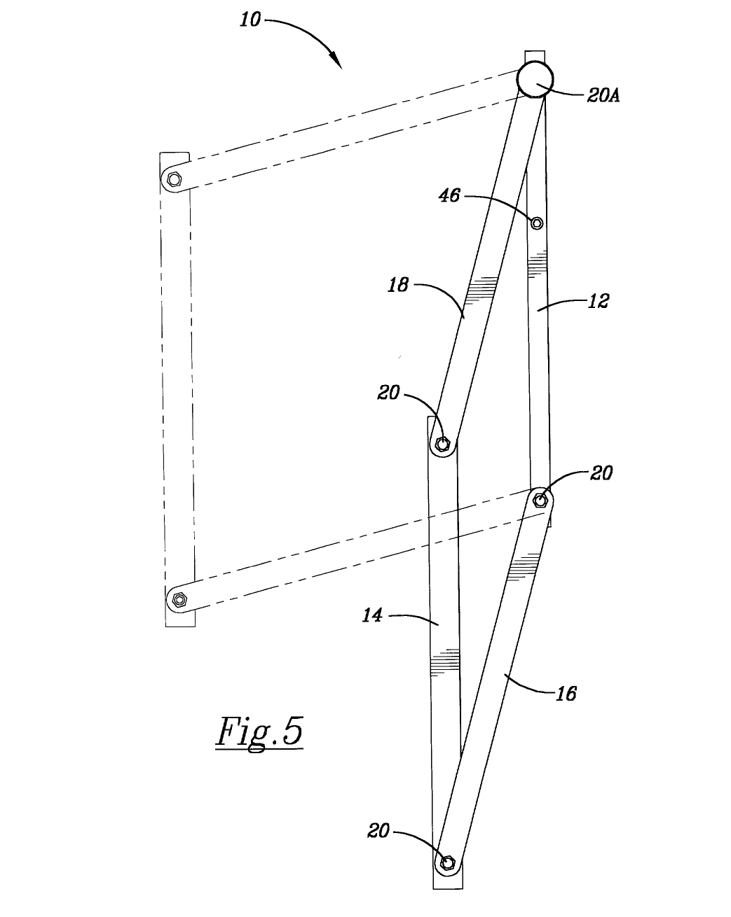

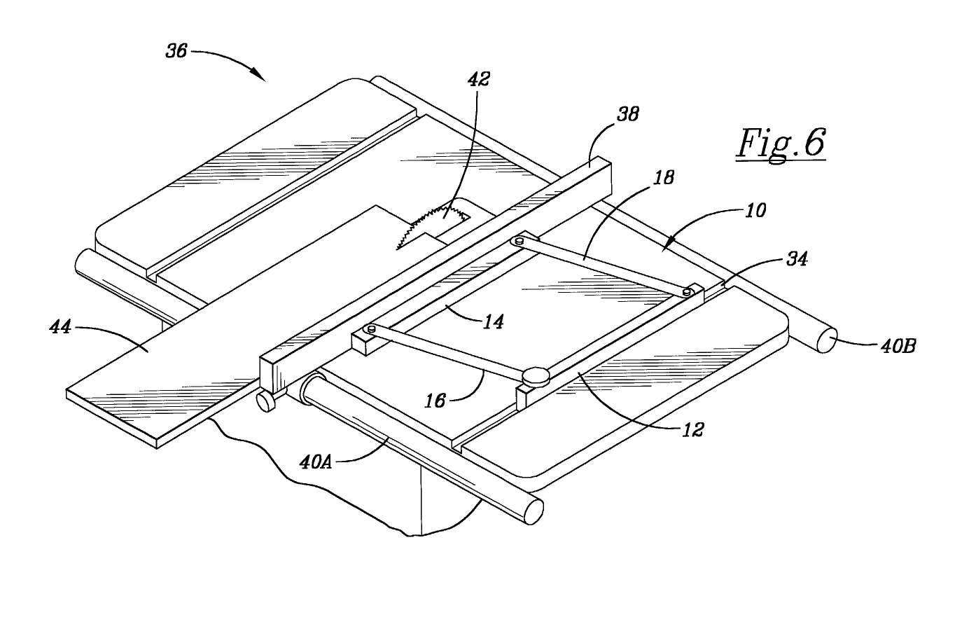

In practice, the setting tool 10 may be utilized to align the saw blade, the rip fence, or any other stop placed or positioned on the table saw. With reference to FIG. 6 the setting tool 10 is shown with its base arm 12 engaging a first machined channel 34 of the table saw 36. The placement of the setting tool 10 into the machined channel 34, which channel is cut in the perpendicular direction to the edge of the table, properly aligns the setting tool 10 base arm 12 in the perpendicular direction to the table edge. In this manner there is no question that the ensuing alignment of table saw elements will be perpendicular to the table edge due to the continuing parallel alignment of the opposing arms of the setting tool 10.

As shown in FIG. 6, the setting tool 10 is expanded to engage the rip fence 38 which has its alignment and position set by tightening screws against position and alignment rails 40A, B along the edges of the table saw. However, due to the width or depth of the table saw, the rip fence may not always be perfectly aligned in a perpendicular configuration to the table edge for the reason that the tightening elements on each rail 40A, B are not operable in conjunction, but separately set. In this manner a misalignment can occur of very minor proportion but which will be magnified as a cut is made across the width or depth of the table. The setting tool 10 of the present invention providing an alignment between the position and alignment rails 40A, B of the table saw 36 prevents even a minimal misalignment as the setting tool 10 provides an alignment arm 14 of sufficient length against which any table saw element may be positioned to provide a guide for both positioning and aligning such element in the desired position and alignment.

In FIG. 6 the rip fence 38 is positioned against the setting tool 10, i.e. alignment arm 14, which has been expanded and set with the tightening knob 30 to a predetermined distance to position and align the rip fence 38 the desired distance and parallel alignment from the saw blade 42. Once the rip fence 38 is positioned against the alignment arm 14 of the setting tool 10, the rip fence 38 may be tightened in position on the position and alignment rails 40A, B with the assurance that the fence 38 is in the appropriate desired position, i.e. parallel distance, from the saw blade 42. Of course the saw blade 42 can also be aligned with the setting tool 10 so that the cutting angle will be perfectly vertical and perpendicular to the table edge. In this manner the rip cut made in the workpiece 44 will be parallel to the lengthwise edges of the workpiece.

The setting tool 10, in order not to fully collapse and possibly destroy the parallelity between its opposing arms, i.e. the base and alignment arms 12, 14 and the extension arms 16, 18, has been fitted with a stop 46 which may be a wooden or metal peg positioned along the base arm 12. Two of the many possible positions for the stop 46 are shown in FIGS. 1 and 2, respectively. The stop 46 prevents the setting tool 10 from being fully collapsed and potentially ruining the parallelity between and among the arms 12-18.

The setting tool 10 can be fashioned from any material, but with the characteristics that such material will not warp, shrink or stretch so that the parallelity between and among the arms 12-18 will not be destroyed. It is also to be understood that the setting tool 10 can be positioned in any machined channel 34 of a table saw 36 regardless of such position being on the left or right of the cutting blade 42. The setting tool 10 can be universally utilized just by reversing the orientation of the tool such that the base arm 12 is engaged in any machined channel or miter cut 34.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A rip guide setting apparatus for use in positioning and aligning elements of a table saw comprising a base arm having a rectangular cross-section for mating with and operatively engaging an alignment reference on the top of said table saw; a positioning and alignment arm positioned opposite the base arm having a height above the table of substantially the same as the base arm; a pair of extension arms extending between the base and positioning and alignment arms; said extension arms fixedly connected at their ends to the opposing respective ends of the positioning and alignment arm and to one opposing end of the base arm; said remaining opposing end of the base arm being connected to the opposing respective end of one of the extension arms to create a parallel relationship between opposing arms with such connections being adjustably tightened to fix the geometric configuration and dimensional extension of the arms for placing one or more elements of said table saw against said positioning and alignment arm to align said one or more elements with said alignment reference.

2. The apparatus of claim 1, wherein the alignment reference being an elongated channel cut into the top of the table and extending from one edge of the table to the other.

3. The apparatus of claim 1, wherein each of said arms at their respective connection points being capable of rotational motion about the connection point.

4. The apparatus of claim 1, further comprising a manually adjustable knob for tightening the connection between the extension arm and the remaining opposing end of the base arm.

5. The apparatus of claim 1, further comprising a stop located on the base arm for preventing the extension arms to over-extend and distort the parallelity of the arms.
